(19) United States
(12) Patent Application Publication
(10) Pub. No.: US 2007/0217917 A1
(43) Pub. Date: Sep. 20, 2007

(54) Rotary fluid dynamic utility structure

(76) Inventor: Sarbuland Khan, Los Angeles, CA (US)

Correspondence Address: ALBERT O COTA, 5460 WHITE OAK AVE, SUITE A-331, ENCINO, CA, 91316, US

(21) Appl. No.: 11/377,162

(22) Filed: Mar. 17, 2006

(51) Int. Cl. B64C 27/46

(52) U.S. Cl. 416/223 R

(57) ABSTRACT

A rotary fluid dynamic utility structure (1) comprising at least two blades, wherein each blade comprises a multiplicity of elemental airfoils (5), a base, a tip (35), a face (14), a back (7), a leading edge (15), a trailing edge (16), and a longitudinal twist. The at least two blades are equi-distantly attached to a hub, which has means for being attached to a rotating shaft. The structure (1) provides five significant improvements over previous blade structures. The first improvement is that the inventive blade's orientation is reversed, the second is that the elemental airfoils (5) are three-dimensionally profiled, the third is an improved blade tip (35) curvature design, the fourth is improved leading and trailing edge ranges, and the fifth is improved mass distribution of the blade.

### TECHNICAL FIELD

The invention generally pertains to rotary fluid dynamic utility structures for rotating blades, and more particularly to a rotary fluid dynamic utility structure that provides increased efficiency by the use of five improvements over previous blade designs.

### BACKGROUND ART

A study of the cross-sectional design of rotating blades (airfoil profiles) in prior art indicates that only one broad class of profiles is used throughout the industries of windmill turbine blades (of horizontal axes), aircraft propellers, helicopter rotors, etc. For reference, this broad class shall be referred to as ‘Class-B Rotary Utility Blade Structures’, which will be fully defined infra.

A blade is comprised of a multiplicity of elemental airfoils 5 i.e., numerous cross-sectional elements each having a designated profile that collectively comprise the blade. These elements usually vary in size, shape and angle across the length of the blade, thereby giving it a twist, but their shape or profile is typically constant.

Examples of prior art airfoil profiles are given in FIGS. 1-6A. Note: all depictions of blades herein as elemental airfoil profiles are cross-sectional views of blades taken from the center of rotation outward, with the rotational axis being vertical, although in reality the rotational axes in all cases are horizontal. FIGS. 1A, 1B and 1C show three examples of the National Renewable Energy Laboratory (NREL) S-Series Airfoil Profiles wherein the straight line is a chord 2. FIG. 2A shows a NASA, NACA and a Wartman variation. The broken lines in FIG. 2A show a hollowed area on the NASA 0417 and the Wartman tail section. FIGS. 2B and 2C are other examples of prior art airfoil profiles. Such airfoil profiles are used for windmill turbine rotors and aircraft propellers. FIGS. 3A and 3B show two examples where a profile is typically used for propeller and windmill blades, one profile is generally closer to the tip of the blade, as shown in FIG. 3A; and a second profile is closer to the hub, as shown in FIG. 3B. In FIGS. 3A and 3B, the direction of the blade spin 3 indicates the encounter with air resistance 4.

FIG. 4 is an example of an elemental airfoil profile 5 based on airplane wing profiling and typically used, with some variations, in the windmill industry for horizontal-axis turbines. The X-X plane is parallel to the plane of rotation of the blade, for which the depicted airfoil 5 is a cross-section at any point along its length. The Y-Y plane is parallel to the direction of the wind 6, which is incident upon the turbine blade and perpendicular to the X-X plane.

For study purposes, the first few moments of the wind impinging on a blade is taken where the blade angles are the angles of attack in the plane of rotation, X-X. The angle Φ is the blade angle between the chord 2 and the X-X plane, and is taken as the angle that an elemental airfoil attacks the air in the plane of rotation as the blade rotates. Since the profile has curvature, the chord 2 is used as a reference for a general angle of Φ. The angle θ is the angle between the Y-Y plane and the chord 2, and is taken as the angle that the incident wind 6 impinges the blade at that particular point on the blade, as the angle of attack perpendicular to the plane of rotation. A P-Q line at right angles to the chord 2 is inserted to delineate the face 14 of the airfoil head, the back 7 of the airfoil head, and the airfoil head 10, for study purposes of this particular example.

The incident wind 6 produces two opposing vectors at the back 7 of the airfoil 5: (1) a vector component 8 rotating the blade and, (2) a vector component 9 resisting that rotation. Further, due to the shape and size of the relative thickness of the airfoil head 10, to the length of the chord 2, both the back 7, and the face 14 of the airfoil head 10 provide resisting surface areas against relative air 20, thereby resulting in a relative vector component 13 that is in opposition to a vector 8.

The chord 2 can be defined as an imaginary line describing the shortest distance between the airfoil's leading edge 15 and its trailing edge 16. The chord 2 is used as a workable reference in producing a twist in the blade of reducing angles of Ø and for studying a profile.

The face 14 of the airfoil 5 is typically slightly convex, but becomes gradually more convex toward the airfoil head 10. The back 7 of the airfoil 5 is more convex than the face 14. In some cases, as in FIGS. 1A, 1B and 1C, the face 14 of the airfoil 5 is slightly concave toward the airfoil tail 17, and where the face 14 of the airfoils 5 in FIGS. 1A and 1C is more convex than the back 7 (NREL series as used for windmills).

The instantaneous direction 3 of the airfoil 5 is perpendicular to the direction of the wind 6. When the incident wind slows down or stops, the airfoil 5 produces a positive lift 18, which has a vector component 19 that opposes the blade's rotation and creates a forward thrust, thus reducing the efficiency of the blade when wind speeds vary.

In the prior art, the airfoil leading edge 15 typically points forward at the angle of the chord 2.

FIG. 5 illustrates an example of a cross-section of a contemporary airplane wing in principle, showing an airfoil profile 5, wherein the length of the airfoil back 7 is greater than that of the airfoil face 14. The airplane moves in a direction 3, thereby creating a relative direction of air 20 that moves faster 21 over the top of the wing than the air 22 over the bottom of the wing, thus creating a lower pressure at the airfoil back 7 compared to its face 14 which produces the lift 18 that is perpendicular to the motion of the wing, at least according to a widely held, yet contested theory. There is yet another factor involved due to the orientation of the airfoil relative to motion: stability. If the wing were reversed, there would still be lift, minus the stability, as a sharp leading edge would tend to move up or down very easily. There is also a certain amount of pressure and resistance 23 developed at the airfoil head.

For a rotary utility blade structure the factor of blade stability is moot since blades are always fixed to a shaft via a hub. Therefore, one can eliminate the disadvantages attendant with the airfoil orientation of prior art, as shown in FIGS. 4 and 5, by reversing the orientation of the airfoil. Thus, in addition to the modifications of prior art blades by the incorporation of one or more aspects of the instant invention, reverse orientation is a major part of the instant invention. Reverse orientation is created by the shifting of the maximum airfoil thickness 24, as shown in FIG. 6A, from the front 11 of the airfoil to a range between the airfoil's middle section 25 to the airfoil's end section 26. FIGS. 6A, 6B and 6C are illustrations using a generic blade rotationally traveling in a direction 3. FIG. 6A shows a typical prior art positioning of the maximum airfoil thickness 24. FIGS. 6B and 6C show the range of positioning to be from the middle section 25 to the end section 26, which is referred to as the efficient zone.

A search of the prior art did not disclose any literature or patents that read directly on the claims of the instant invention. However, the following U.S. patents are considered related:

| PATENT NO. | INVENTOR | ISSUED |
|---|---|---|
| 6,800,956 | Bartlett | 5 Oct. 2004 |
| 5,474,425 | Lawlor | 12 Dec. 1995 |
| 4,408,958 | Schacle | 11 Oct. 1983 |

The U.S. Pat. No. 6,800,956 patent discloses a system for the generation of electrical power using an improved 600-watt to 900-watt wind turbine system. The system comprises a wind driven generator utilizing an array of uni-directional carbon fiber turbine blades, an air-ducting nose cone, and a supporting tower structure. Additionally, a method of blade fabrication utilizing expanding foam, to achieve improved blade edge strength, is disclosed. The support tower utilizes a compressive coupler that permits standard fence pipe to be joined without welding or drilling.

The U.S. Pat. No. 5,474,425 patent discloses wind turbine rotor blades having a horizontal axis free yaw and that is self-regulating. The blades are designed by employing defined NREL inboard, midspan, and outboard airfoil profiles and interpolating the profiles between the defined profiles and from the latter to the root and the tip of the blades.

The U.S. Pat. No. 4,408,958 patent discloses a wind turbine blade of large size for a wind turbine having three blades and that is used to generate electrical power. The cross section of the blade tapers from a configuration at the hub end with substantial leading and trailing edge deflection toward the wind providing high lift at low speed.

For background purposes and as indicative of the art to which the invention relates, reference may be made to the following remaining patents found in the search:

| PATENT NO. | INVENTOR | ISSUED |
|---|---|---|
| 6,752,595 | Murakami | 22 Jun. 2004 |
| 6,582,196 | Andersen, et al | 24 Jun. 2003 |
| 6,302,652 | Roberts | 16 Oct. 2001 |
| 6,132,181 | McCabe | 17 Oct. 2000 |
| 5,161,953 | Burtis | 10 Nov. 1992 |
| 4,976,587 | Johnston, et al | 11 Dec. 1990 |
| 4,969,800 | Parry, et al | 13 Nov. 1990 |
| 4,698,011 | Lamalle, et al | 6 Oct. 1987 |

### DISCLOSURE OF THE INVENTION

In its most basic design, the rotary fluid dynamic utility structure is comprised of the following major elements:

At least two blades, wherein each blade comprises:
1. a multiplicity of elemental airfoils that form the longitudinal length of each of the at least two blades,
2. a base,
3. a tip,
4. a face,
5. a back,
6. a leading edge,
7. a trailing edge, and
8. a longitudinal twist.

The at least two blades are equidistantly attached to a hub, and the hub has means for being attached to a rotating shaft. In addition to the major elements, each of the elemental airfoils comprises:
1. a head,
2. a tail,
3. a leading edge,
4. a trailing edge,
5. a back,
6. a face, and
7. a profile.

The rotary fluid dynamic utility structure provides five significant improvements over previous conventional rotating blade structures. The improvements are:
1. reverse orientation of the blade, i.e. the blade cross-sections or the elemental airfoil profiles are reversed in the horizontal plane,
2. three dimensional airfoil profiling,
3. correct blade tip curvature design,
4. improved leading and trailing edge ranges, and
5. improved longitudinal blade mass distribution.

For windmill use, to minimize erosion and corrosion, at least part of each blade is coated with an appropriate material, such as one of the available metallic or non-metallic materials and compounds, including resins, synthetic fluorine-containing resins, polyurethane paint and ultra-violet inhibiting systems such as resin additives and other UV barriers.

In view of the above disclosure, the primary object of the invention is to provide a rotary fluid dynamic utility structure of dynamic blades having superior performance efficiency in any field of rotary blade application.

It is also an object of the invention to provide a rotary fluid dynamic utility structure that:
can be used for boat and ship propellers, windmill blades, hydroelectric power generating turbines, aircraft propellers, helicopter rotors, fans, model planes and any other applicable use,
can be made in various sizes and shapes of blades for different applications,
can be made of various materials, such as metal, wood, plastic, fiberglass, carbon fiber, or composite materials etc.,
can be manufactured cost effectively and
can be easily retrofitted to existing structures or vehicles (such as windmills and airplanes).

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIGS. 1A-1C are cross-sectional views of windmill blades having NREL, S-Series airfoil profiles.

FIGS. 2A-2C are cross-sectional views showing examples of the airfoil profiles of prior art blades.

FIGS. 3A and 3B are cross-sectional views showing airfoil profiles of conventional aircraft propellers.

FIG. 4 is a cross-sectional view of a typical blade showing an elemental airfoil profile as used for windmill and aircraft propellers.

FIG. 5 is a cross-sectional view of an aircraft wing illustrating lift and air resistance.

FIGS. 6A-6C are cross-sectional views showing the placement of maximum airfoil thickness compared to the conventional placement prior to three-dimensional profiling.

FIGS. 7A-7D are cross-sectional views showing three-dimensional airfoil profiling.

FIG. 8 is a cross-sectional view showing leading and trailing edge termination ranges prior to three-dimensional profiling.

FIGS. 9A-9C are cross-sectional views showing elemental airfoil designs for windmills prior to three-dimensional profiling.

FIGS. 10A-10D are cross-sectional views of various blade designs for aircraft prior to three-dimensional profiling.

FIGS. 11A-11D are cross-sectional views of further blade designs for aircraft prior to three-dimensional profiling.

FIGS. 12A-12E are examples of line profiled blades prior to three-dimensional profiling.

FIGS. 13A-13E are front elevational views of conventional blades with various tip designs.

FIGS. 14A-14C are front elevational views of blades showing the principle behind correct tip curvatures.

FIG. 15 is a front elevational view of a rotary fluid dynamic utility blade structure.

### BEST MODE FOR CARRYING OUT THE INVENTION

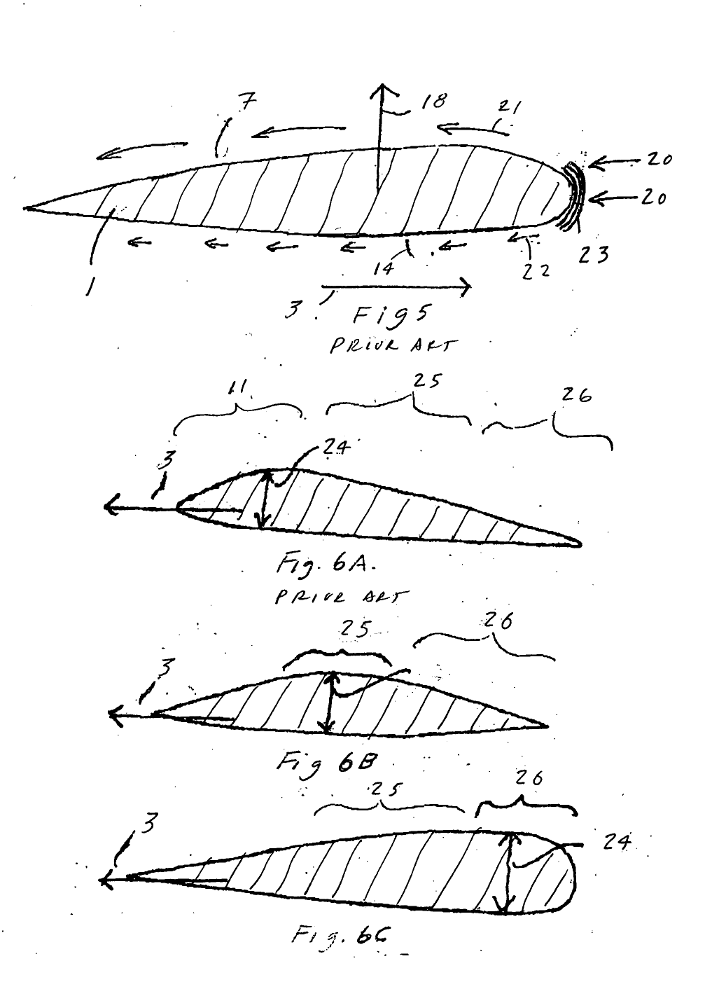

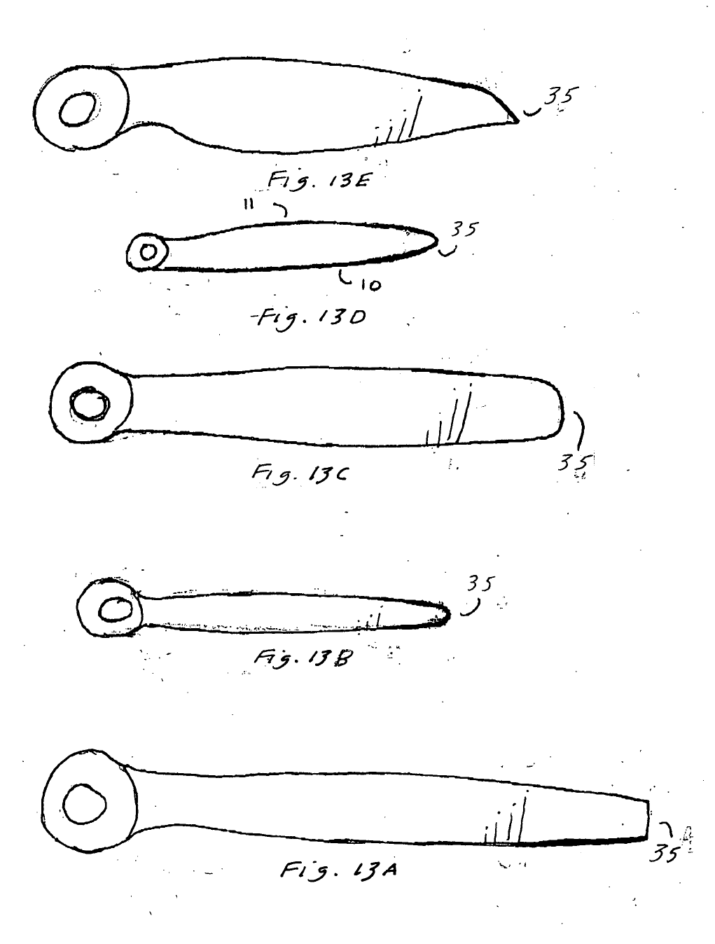

The best mode for carrying out the invention is presented in terms of a preferred, a second, a third and a fourth embodiment for a Rotary Fluid Dynamic Utility Structure, (hereinafter “RFDUS 1”). The preferred embodiment is shown in FIGS. 6B,6C,7C, 7D, 8, 9A, 14C and 15. The second embodiment is shown in FIGS. 6B, 6C,7C,7D,8, 10C, 14C and 15. The third embodiment is shown in FIGS. 8, 12E,14C and 15, and the fourth embodiment is shown in FIGS. 8, 12B, 14C and 15.

The RFDUS 1 is an improvement in the design of rotating blades and is applicable to a wide range of uses, including boat and ship propellers, windmill and hydroelectric turbine blades, aircraft propeller blades, helicopter rotors, fans, model planes, and any other similar application where rotating blades are utilized.

The RFDUS 1 provides five significant improvements over previous blade structure designs. Although all five improvements, as described supra, comprise the RFDUS 1, any one or more of the improvements can be utilized. Additionally, any one or more of the five improvements can be incorporated into the design of a prior art blade in order to improve its efficiency.

The preferred embodiment of the RFDUS 1 comprises at least two blades, each of which conform to parameters 1-7 of a Class A blade. Please note: that the parameters of a Class A blade, a Class B blade and a Class C blade are disclosed infra.

In the second embodiment, each blade conforms to parameters 1-6 and 8 of a Class A blade.

In the third embodiment, each blade is line profiled and conforms to parameters 3, 5, 6 and 7 of Class A blade.

In a fourth embodiment each blade is line profiled and conforms to parameters 3, 5, 6 and 8 of a Class A blade.

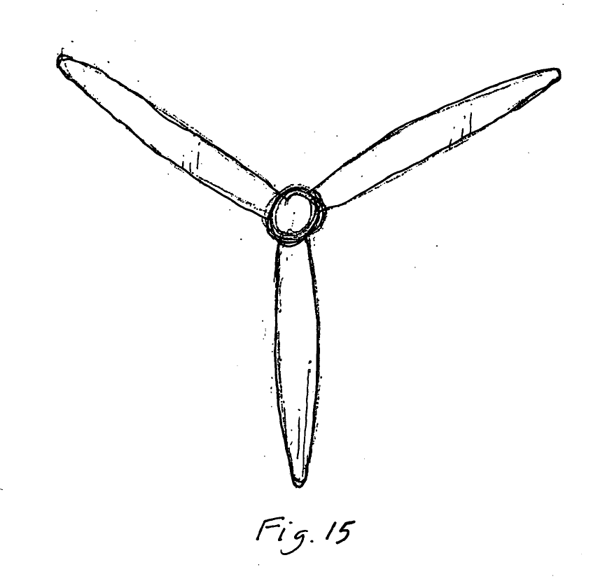

These embodiments are each comprised of at least two blades, with three blades shown in FIG. 15, whose dimensions and parameters, other than covered by the instant invention and variations thereof, are perforce, variable according to user requirements as is the case with all prior art.

It should be noted that the RFDUS 1 disclosed herein can be utilized in any blade structure for rotating blades that operate in a fluid, whether fluid-driven, as for producing electricity; or motor-driven, as for producing thrust.

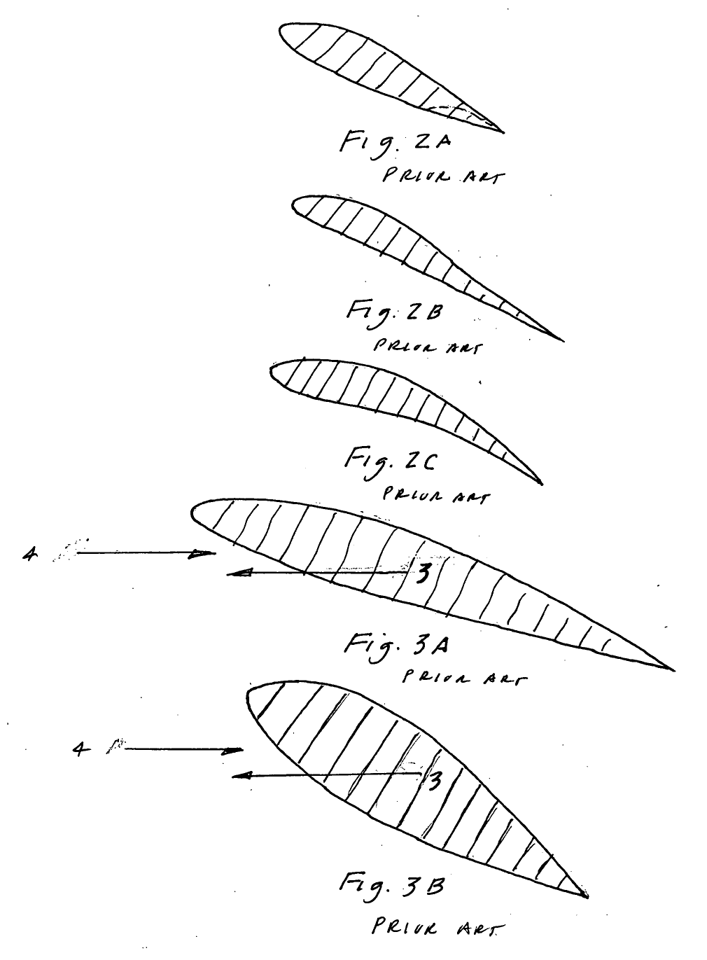

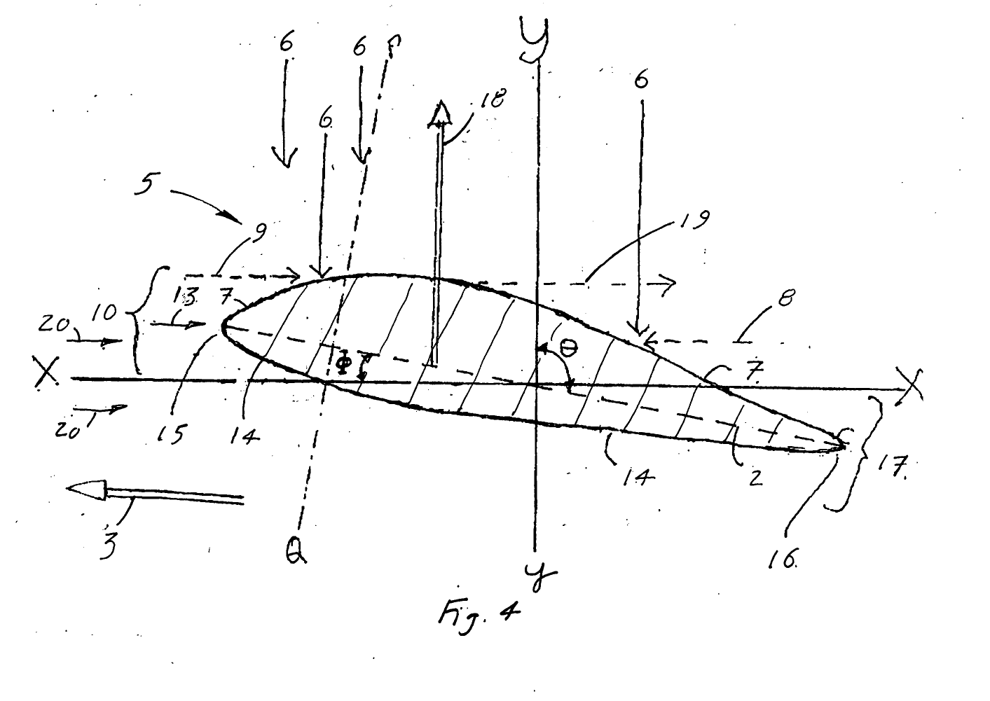

For a rotary utility blade structure, the factor of blade stability is moot, since blades are always fixed to a shaft via a hub. Therefore, one can eliminate the disadvantages, as shown in FIGS. 4 and 5, attendant with the airfoil orientation of prior art by reversing the orientation of the airfoil. Thus, in addition to the modification of prior art blades by one or more aspects of the instant invention, reverse orientation is a major element of the instant invention. Reverse orientation is defined as the shifting of the maximum airfoil thickness, as shown in cross-sections in FIG. 6A, from the front of the airfoil to a range between the airfoil's middle section to the airfoil's end section. FIGS. 6A, 6B and 6C are cross-sections using a generic blade rotationally traveling in a direction. FIG. 6A shows a typical prior art positioning of the maximum thickness of the blade. FIGS. 6B and 6C show the range of positioning to be from the middle section to the end section, which is referred to as the efficient zone. As a generic representation, it is not necessarily meant to depict recommended sizes, proportions or shapes except the range of placement of maximum airfoil thickness. This can be applied to any use of a blade in a rotating system.

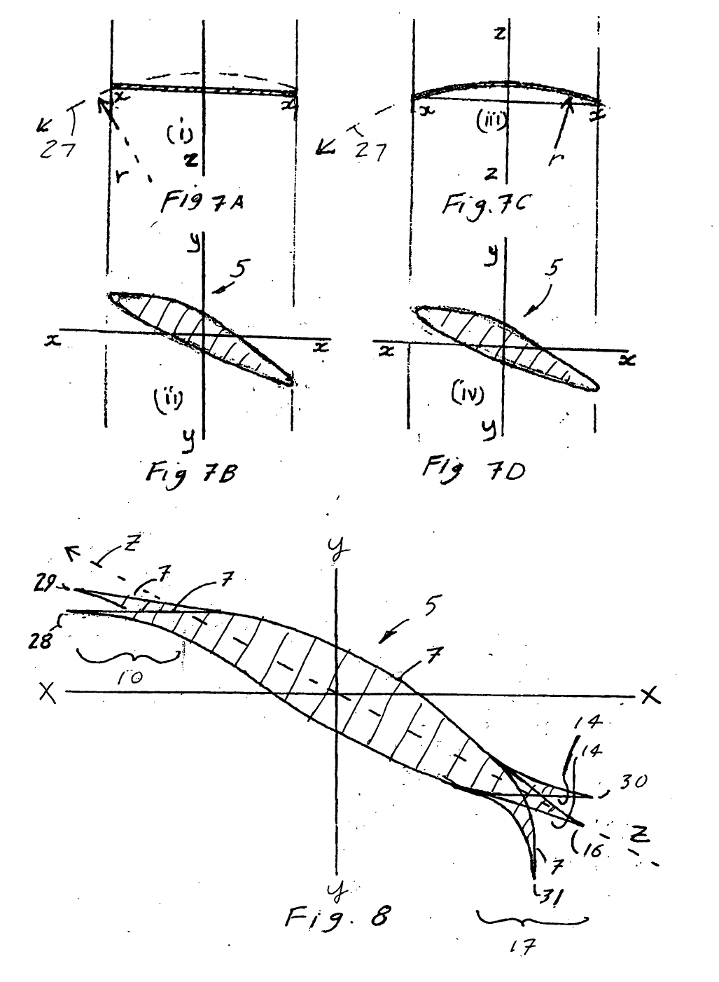

Prior art airfoil profiles of rotating blades as used for aircraft and windmills are typically profiled in two dimensions, which is preferable for linear motion. Since rotating blades have circular motion, the most efficient profiling requires the blades to be profiled in three dimensions as shown in FIGS. 7A-7D. FIG. 7A is a plan view of a single elemental airfoil profiled in two dimensions, and FIG. 7B is its side view. The rotational path 27 of the airfoil 5 for the rotating blade is shown in FIGS. 7A and 7C. The elemental airfoil, as shown in FIGS. 7C and 7D, has a radius, “r”, from the center of its rotation. FIG. 7C is a plan view, and FIG. 7D is a side view of a single elemental airfoil profiled in three dimensions using the same radius, r, according to the instant invention. Thus an entire rotary utility blade can be comprised of three-dimensionally profiled airfoils, which cause the blade to be more dynamic and efficient.

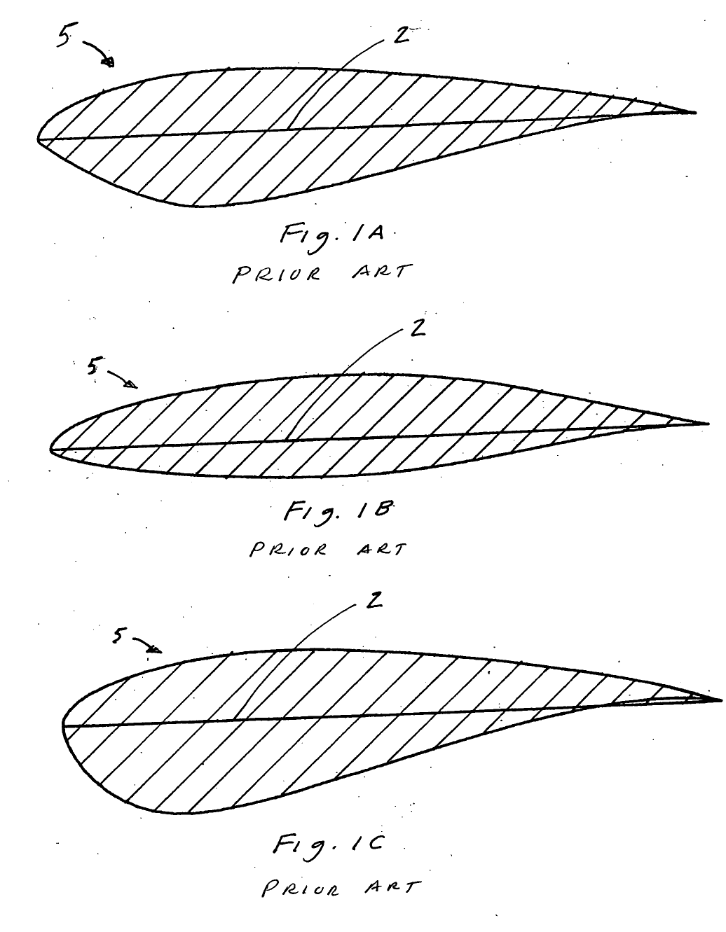

In prior art the leading and trailing edges of a blade typically terminate along the chord 2 or point in the direction of the general inclination of the entire elemental airfoil 5. In atypical cases, the trailing edge 16 terminates slightly toward the plane of rotation (i.e., slightly away from the chord 2, and toward the plane of rotation), as in the examples shown in FIG. 1C and FIG. 2C. The instant invention requires that both ends of a blade terminate within a specific efficient range for each end, which reduces air resistance at the leading edge, and turbulence at the trailing edge, in a manner that reduces drag (referred to as the efficient ranges). FIG. 8 is an illustration of the efficient ranges of termination. The inclined airfoil shows two termination positions and angles at the airfoil head 10 and three positions at the airfoil tail 17. The termination range of the airfoil head for all uses of a blade is:

From zero degrees 28 to the plane of rotation, X-X, (i.e., parallel to it) to any angle 29 to the general inclination Z-Z of the airfoil 5 (or angle Φ—angle of chord to plane of rotation) by (i.e., measured from) the back 7 of the airfoil head 10.

The tail termination differ according to use:

1. For kinetic energy conversion (e.g., windmills), the range is:
From zero degrees 30 to the plane of rotation (parallel to X-X plane) to the inclination of the chord, or general inclination Z-Z of the airfoil 5 by the face 14 of the airfoil tail 17.

2. For use as a propeller the range is:
From the general inclination of the airfoil, as shown by the broken lines Z-Z (or the angle of the chord), to 90° to the plane of rotation, or an inclination 31 that is parallel to the Y-Y axis adjacent the back 7 of the airfoil tail 17, as shown in FIG. 8. The actual termination angles are dependent on several factors such as blade angles used, rpm's, blade size, wind speed, etc.

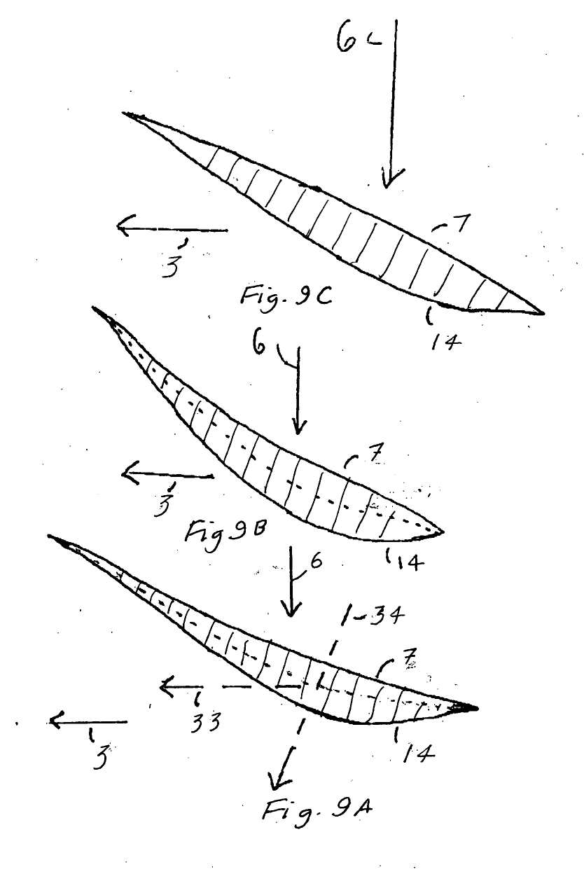

The placement of the maximum thickness of the airfoil from the front of the airfoil creates air resistance at the front, similar to any prior art blade that is patterned after an airplane wing. Thus the shift of the placement of maximum airfoil thickness resolves problems inherent in conventional airfoil designs. Further, when the airfoil face 14, as shown in FIGS. 9A-9C, is made longer than the airfoil back 7, a substantial negative lift component 33 in the direction of rotation 3 of the blade, as shown in FIG. 9A, will aid in the rotation of the blade. The total negative lift vector 34 is indicated by the arrow and the wind direction 6, as also shown in FIG. 9A.

A misconception in utilizing an airplane wing cross-section model in rotating systems used to convert fluid kinetic energy is the pressure differential between the airfoil's face and its back. When such a blade is used to convert kinetic energy, as in windmills, it is evident that there is no low pressure on the back 7 of the airfoil 5 despite any blade profiling. There is actually a higher pressure on the back 7 of the airfoil 5 than on the face 14, which reduces and normalizes under constant wind velocity as the blade picks up speed. The pressure on the face 14 of the airfoil 5 increases, and for aircraft propellers the pressure reverses. Thus the back 7 and the face 14 of the elemental airfoil 5 are profiled according to the instant invention.

FIGS. 9A-9C illustrate three examples of the inventive blade structure for use in windmills. FIGS. 9A and 9B are examples of the concave airfoil back 7, and FIG. 9C where the back 7 is slightly convex. Note: reverse orientation will require a certain amount of narrowing of the airfoil tail to a point, in order to minimize turbulence and eliminate low pressure build-up in the wake of the blade, in a manner that reduces drag. The broken lines in FIGS. 9A and 9B show further examples of airfoil back profiles.

Note: FIGS. 9,10 and 11 are depicted in two dimensions for ease of illustration and therefore do not depict the blade's actual cross section, which will have a third dimension added to the profiles.

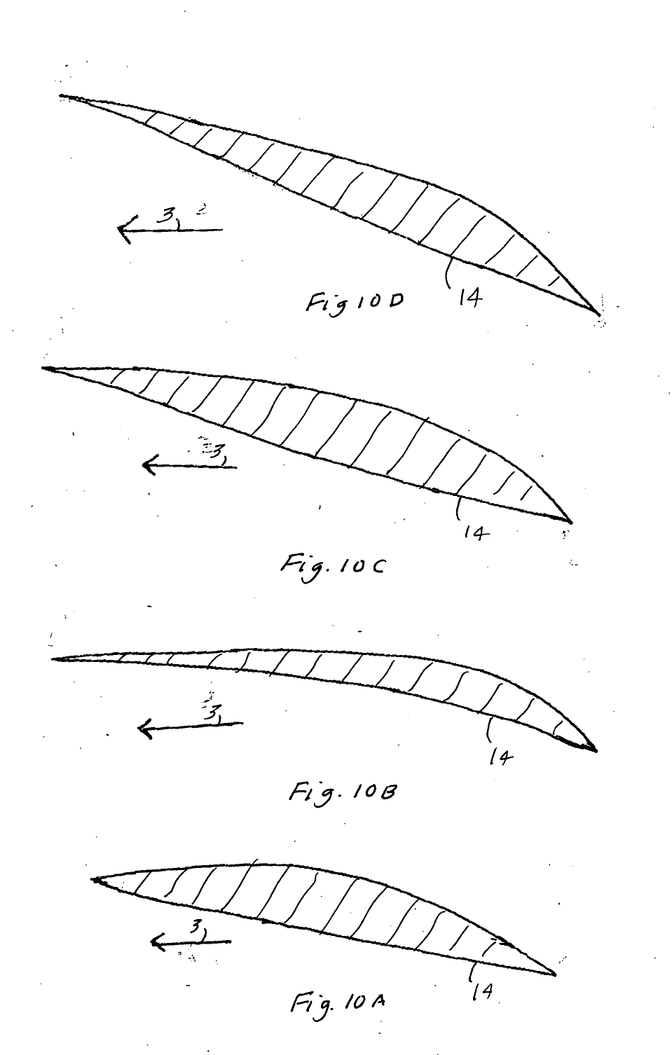

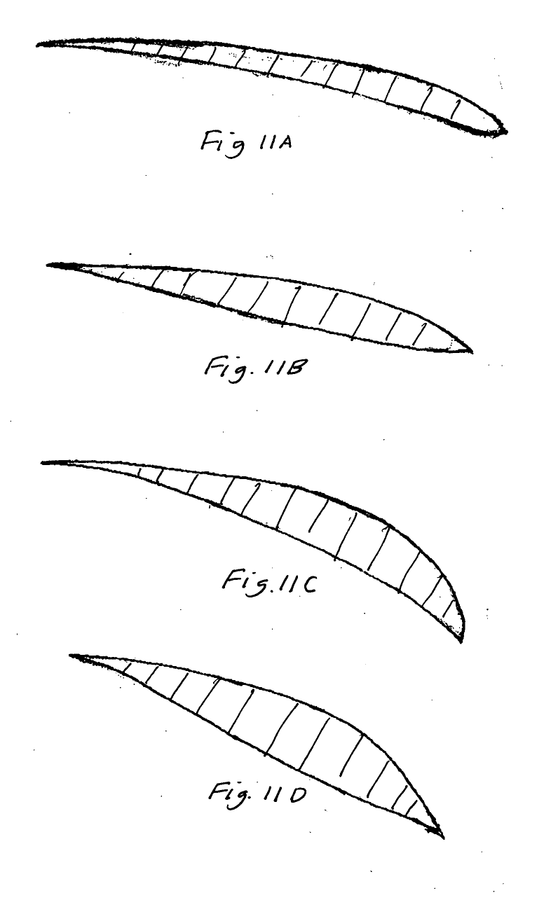

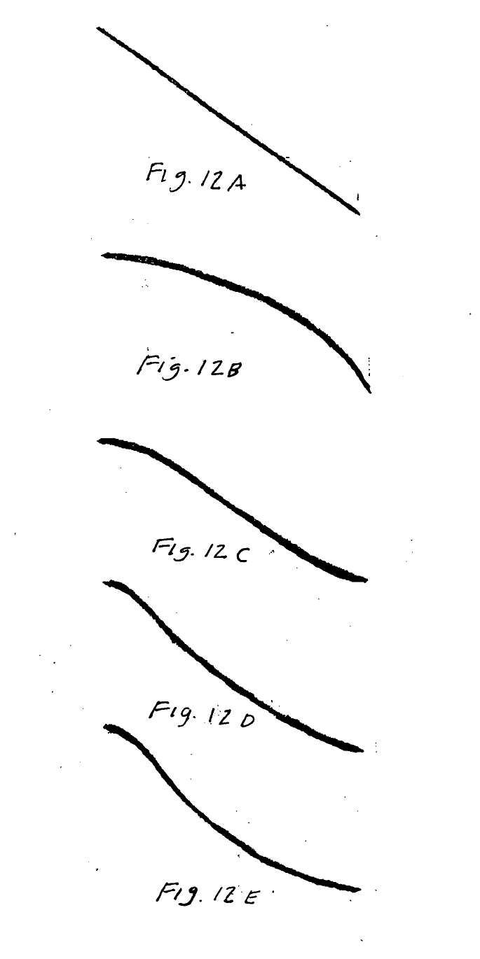

FIGS. 10A-10D illustrate examples of the inventive blade structure for use in propelling an aircraft. FIGS. 10A, 10C and 10D show examples of a convex airfoil face 14, and FIG. 10B shows a concave airfoil face 14, with arrows indicating the direction 3 of rotation. FIGS. 11A-11D illustrate further examples of the inventive blade structure for propelling an aircraft.

The curvatures of the back and face of the profiles are designed to account for changing angles of attack due to changing blade speeds, wind speeds, etc. (variables) to give a more constant blade efficiency over a larger range of variables, such as wind velocities for windmills and acceleration for aircraft.

Line profiling is particularly useful in kinetic energy conversion where the net gain of lift versus air resistance is negative (i.e., where any lift design of varying airfoil thickness creates greater air resistance than the required negative lift). Line profiling is also effective for model planes, fans, etc. A line profile is defined as a blade's elemental airfoil profile where the length of the back and face of the profile are equal, thus producing a blade having constant thickness, producing desired lift when rotating according to profile curvatures, blade angles, and can be represented by a line. Examples of the cross-sections of line profiled blades are given in FIGS. 12A-12E. Note: the leading and trailing edges are pointed and within the termination efficient ranges. FIG. 12B is an example of a positive lift line profile, and FIG. 12D and FIG. 12E show negative lift profiles.

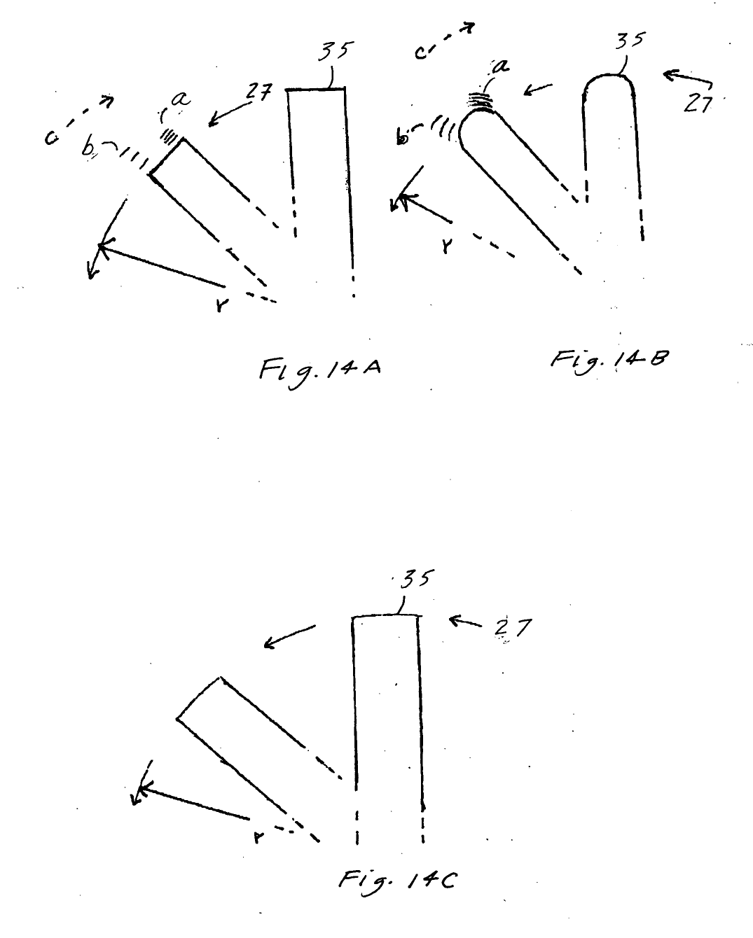

FIGS. 13A-13E illustrate examples of conventional blades. The tip 35 profiling for such blades ranges from being flat and straight, as shown in FIG. 13A; flat and angled, as shown in FIG. 13E; to some arbitrary curvature, as shown in FIGS. 13B, 13C and 13D.

FIGS. 14A-14C illustrate the basics of tip fluid dynamics: the blades rotational path is 27, and r is the radius of rotation of the blade, which is the distance from the center of rotation to the blade tip 35. FIG. 14A shows a flat-tipped blade, and FIG. 14B shows a blade with an arbitrary curvature. The letter “a” indicates air compression on one side of the tip 35, and “b” rarefaction of air on the other side. The air compression resists the spin of the blade, and the rarefaction has a vector component “c” that is in opposition to the direction of rotation. This causes resistance to the spin of the blade, whose value is amplified by the product of the radius of rotation and the blade's rpm.

FIG. 14C shows a blade with a curvature of radius r as viewed from a front elevation perspective. As a result of the inventive curvature, the tip 35 resistance is reduced considerably, thereby increasing the efficiency of the utility blade.

FIG. 15 is an example of the RFDUS 1 utilizing a three blade system.

To increase blade response to motive power applied to it, its distribution of mass must conform to the formula:
xy=c
where x=the mass of an elemental airfoil or a small unit section of a blade at a point where the rotational radius or mean rotational radius is y (i.e., its distance from the center of rotation), and c is constant throughout the length of the blade. In other words, the rotational inertia about the center of rotation must be constant along the blade. This reduces the lag in starting the rotation of the blade and in the acceleration and deceleration of the blade, thus reducing fuel consumption when used as propeller and reducing the start wind velocity when used as a windmill rotor. Prior art has been found not to fully conform to this formula. At least a one-third section of the blade should conform to this mass distribution. A blade with a longitudinally constant inertia does not have intrinsic inertial drag, thereby making such a blade more dynamic. In windmill applications, for example, the energy captured from sudden gusts of wind that are typically present in urban settings is increased substantially. Additionally, at least a portion of each blade has a longitudinal twist. The longitudinal twist of a blade has a reducing rate of angle Ø to the tip.

In order to distinguish between conventional rotary blades as a class of blades, and the rotary utility blade of the instant invention as another class, Class A, Class B, and Class C parameters are defined below:

Class-A Category of Blades

1. Blade orientation is reverse of an airplane wing, at least in the horizontal plane—having a tapering, sharp leading and trailing edges for greater efficiency. (The angles between the back and face of the airfoil head—closer to the airfoil tip, are small enough not to offer a larger resisting surface to the direction of the relative air).

2. All blade elemental airfoils are thicker toward the airfoil tail and narrow to a point at the airfoil head, whereupon the maximum airfoil thickness placement is in the efficient zone.

3. At least one-third of blade mass distribution conforms to the formula: xy=c.

4. The elemental airfoils are three-dimensionally profiled.

5. Blade tip is curved by its rotational radius, as viewed from an elevation perspective.

6. Both ends of the elemental airfoils terminate within the airfoil termination efficient ranges.

7. Only negative lift airfoil profiling is used for energy conversion purposes, with the exception of straight line-profiling (see FIG. 12A).

8. Only positive lift airfoil profiling is used for propulsion purposes, with the exception of straight line-profiling (see FIG. 12A).

Class-B Category of Blades

A Class-B category blade is defined as a conventional blade used in a system of rotating blades that satisfies the following criteria:

1. Blade orientation is based on, and is, the same as that of an airplane wing—i.e., the cross-section of each blade is thicker toward the leading edge and tapers toward the trailing edge. (The angles between the back and face of each airfoil head, toward the airfoil tip, are large enough to significantly increase forward air resistance, thus contributing to stall conditions).

2. Blade is comprised of an elemental airfoil profile that resembles the general elemental airfoil profiles of an airplane wing in their orientation—i.e., the airfoil head is thicker than the airfoil tail, whether or not the aircraft's back is longer than its face.

3. Blade mass distribution does not conform to the formula: xy=c.

4. Elemental airfoils are only two-dimensionally profiled.

5. Blade tip shape does not conform to a curvature of radius r, where r=the rotational radius of any point on the tip, as viewed from a front elevation perspective.

6. At least one of the elemental airfoil ends does not terminate within the airfoil termination efficient range.

Class-C Category of Blades

A Class-C blade, for the purpose of the instant invention, is defined as a Class-B blade as improved by one or more aspects of a Class-A blade.

Specific shapes and sizes of a blade including blade twist, whether used as a fan, propeller or windmill rotor etc., are numerous. The factors that govern the above designs include (other than the factors covered above) market or user requirements and other principles not included herein, but well known to those knowledgeable in this field. However, the principles covered herein and the efficiency ranges of parameters etc. given herein allow for a wide choice in design.

While the invention has been described in detail and pictorially shown in the accompanying drawings it is not to be limited to such details, since many changes and modifications may be made to the invention without departing from the spirit and the scope thereof. Hence, it is described to cover any and all modifications and forms which may come within the language and cope of the claims.

1. A rotary fluid dynamic utility structure comprising:
a) at least two blades wherein each blade comprises:
(1) a multiplicity of elemental airfoils that extend along the longitudinal length of each said at least two blades,
(2) a base,
(3) a tip,
(4) a face,
(5) a back,
(6) a leading edge,
(7) a trailing edge and
(8) a longitudinal twist
b) a hub to which are equidistantly attached said at least two blades, and
c) means for attaching said hub to a rotating shaft.

2. The structure as specified in claim 1 wherein each of the elemental airfoils comprises:
a) a head,
b) a tail,
c) a leading edge,
d) a trailing edge,
e) a back,
f) a face, and
g) a profile.

3. The structure as specified in claim 2 wherein said profile comprises:
a) a reverse orientation that tapers toward the leading edge, and
b) a maximum thickness that is located within a range at an efficient zone that encompasses the substantial center of the airfoil to its end section.

4. The structure as specified in claim 3 wherein the maximum thickness of the airfoil is within the efficient zone.

5. The structure as specified in claim 2 wherein the leading edge and the trailing edge terminate within efficient ranges for fluid kinetic energy conversion and for propulsion, respectively.

6. The structure as specified in claim 5 wherein the efficient range for the leading edge termination for both fluid kinetic energy conversion and for propulsion is from zero degrees to the plane of rotation to any angle to the general inclination of the airfoil, as measured from the back of the airfoil head.

7. The structure as specified as claim 5 wherein the efficient range for the trailing edge termination for fluid kinetic energy conversion is from zero degrees to the plane of rotation to the general inclination of the airfoil or the blade angle, as measured from the face of the airfoil tail.

8. The structure as specified in claim 5 wherein the efficient range for the trailing edge termination for propulsion is from the general inclination of the airfoil or the blade angle to 90° to the plane of rotation, as measured from the back of the airfoil tail.

9. The structure as specified in claim 1 wherein at least one-third of the length of each said blade has a mass that is distributed according to the formula xy=c, wherein x=the mass of the elemental airfoil or a unit section of said blade, y is the elemental airfoil rotational radius or the unit section's mean rotational radius, and c is constant for that length of the blade.

10. The structure as specified in claim 2 wherein the elemental airfoils are profiled in three dimensions.

11. The structure as specified in claim 1 wherein each said blade has a reverse orientation.

12. The structure as specified in claim 1 wherein each said blade is line profiled and conforms to Class-A category parameter 3, 5, 6 and 7.

13. The structure as specified in claim 1 wherein each said blade conforms to Class-A category parameters 1-6 and 8, or 1-7.

14. The structure as specified in claim 1 wherein each said blade can be designed to have a positive lift or a negative lift.

15. The structure as specified in claim 1 wherein the base is integral with the hub.

16. The structure as specified in claim 1 wherein the tip is curved by its rotational radius.

17. The structure as specified in claim 2 wherein the shape of the face of the airfoil is selected from the group consisting of convex, substantially convex, concave, substantially concave, flat, substantially flat or a combination thereof.

18. The structure as specified in claim 2 wherein the shape of the back of the airfoil is selected from the group consisting of convex, substantially convex, concave, substantially concave, flat, substantially flat or a combination thereof.

19. The structure as specified in claim 2 wherein the length of the airfoil's back is greater than the length of the airfoil's face.

20. The structure as specified in claim 2 wherein the length of the airfoil's back is less than the length of the airfoil's face.

21. The structure as specified in claim 2 wherein the airfoil's leading edge and trailing edge terminate within an efficient range.

22. The structure as specified in claim 2 wherein said airfoil tail terminates at a point in a manner that reduces drag.

23. The structure as specified in claim 2 wherein at least part of said blade further comprises a coating.

24. The structure as specified in claim 1 wherein at least part of each blade has a longitudinal twist that has a reducing rate of angle Φ to the tip.

25. The structure as specified in claim 1 wherein the rotating shaft is driven by a motor or by said blades being acted upon by a moving fluid.
